(19) United States
(12) Patent Application Publication
(10) Pub. No.: US 2017/0303568 A1
(43) Pub. Date: Oct. 26, 2017

(54) OIL AND FAT COMPOSITION FOR RICE COOKING AND METHOD FOR MANUFACTURING BOILED RICE

(71) Applicant: J-OIL MILLS, INC., Tokyo (JP)

(72) Inventors: Takeshi SUZUKI, Tokyo (JP); Hiroatsu HAGIRI, Tokyo (JP); Kenichi WATANABE, Tokyo (JP)

(21) Appl. No.: 15/448,977

(22) Filed: Mar. 3, 2017

(30) Foreign Application Priority Data
Apr. 20, 2016 (JP) 2016-084847
Oct. 27, 2016 (JP) 2016-210840

(51) Int. Cl. A23L 3/3499; A23L 7/196; A23B 9/26

(52) U.S. Cl. CPC A23L 3/3499; A23B 9/26; A23L 7/196; A23V 2002/00

(57) ABSTRACT

[Problem]

It is an object of the present invention to provide an oil and fat composition for rice cooking, which can suppress hardening of boiled rice during chilled storage and with which boiled rice with reduced odor specific to rice species in Indica rice or the like can be cooked, by adding the composition when cooking raw rice.

[Solution]

The present invention is an oil and fat composition for rice cooking, characterized by containing oils and fats as well as 0.1% to 3% by mass of lecithin and 0.002% to 1% by mass of ascorbic acid analog compound.

### TECHNICAL FIELD

The present invention relates to an oil and fat composition for rice cooking, and a method for manufacturing boiled rice using the same.

### BACKGROUND ART

For conventional oil and fat compositions for rice cooking, for example a method in which a polyglycerol condensed ricinolein ester is mixed in oils and fats (Patent Document 1), a method in which an organic acid monoglyceride is mixed (Patent Document 2) or a method in which these emulsifiers are combined (Patent Documents 3 and 4) have been proposed. However, in some of these compositions, oils and fats hardly disperse evenly in boiled rice, and none of them are disclosed in relation to suppressions of hardening of the boiled rice during chilled storage and of odor specific to Indica rice or the like.

### PRIOR ART DOCUMENTS

### Patent Documents

Patent Document 1: JP 1991-175940 A

Patent Document 2: JP 1995-298843 A

Patent Document 3: JP 1995-274859 A

Patent Document 4: JP 1996-154603 A

### SUMMARY OF INVENTION

### Problem to be Solved

It is an object of the present invention to provide an oil and fat composition for rice cooking, which can suppress hardening of boiled rice during chilled storage and with which boiled rice with reduced odor specific to rice species in Indica rice or the like can be cooked, by adding the composition when cooking rice.

### Solution to Problem

As a result of intensive studies to solve the above-mentioned problems, the present inventors found that hardening of boiled rice during chilled storage could be suppressed and an ascorbic acid analog compound when cooking raw rice, and that boiled rice with reduced odor specific to rice species in Indica rice or the like could be cooked, by adding an oil and fat composition containing a predetermined amount of lecithin, thereby completing the present invention.

That is, the present invention is an oil and fat composition for rice cooking, which contains oils and fats as well as 0.1% to 3% by mass of lecithin and 0.002% to 1% by mass of ascorbic acid analog compound.

Preferably, the ascorbic acid analog compound is an ascorbic acid ester.

Preferably, a content of acetone insoluble matters in the lecithin is 50% to 100% by mass.

In addition, preferably, the oil and fat composition for rice cooking contains one or two or more oils selected from rice oil, rapeseed oil and soybean oil.

Preferably, the total amount of the rice oil, the rapeseed oil and the soybean oil is not less than 80% by mass.

The present invention is also a method for manufacturing boiled rice, which comprises adding, relative to 100 parts by mass of raw rice, 0.1 parts to 5 parts by mass of the oil and fat composition containing 0.1% to 3% by mass of lecithin and 0.002% to 1% by mass of ascorbic acid analog compound, and cooking the raw rice with the oil and fat composition added.

The present invention is also a method for suppressing Indica rice-specific odor of boiled rice, which comprises adding, relative to 100 parts by mass of the raw rice, 0.1 parts to 5 parts by mass of the oil and fat composition containing 0.1% to 3% by mass of lecithin and 0.002% to 1% by mass of the ascorbic acid analog compound, when manufacturing boiled rice by cooking raw rice containing Indica rice. In particular, the Indica rice-specific odor caused after chilled storage of the boiled rice can be suppressed.

The raw rice contains preferably 50% to 100% by mass, more preferably 80% to 100% by mass, even more preferably 90% to 100% by mass, and most preferably 100% by mass of Indica rice.

The present invention is also a method for suppressing hardening of boiled rice during chilled storage, which comprises adding, relative to 100 parts by mass of the raw rice, 0.1 parts to 5 parts by mass of the oil and fat composition containing 0.1% to 3% by mass of lecithin and 0.002% to 1% by mass of ascorbic acid analog compound, when manufacturing boiled rice by cooking raw rice. Herein, the chilled storage means storage at 2° C. to 10° C.

The present invention is also a method for suppressing undesirable odor of boiled rice, which comprises adding, relative to 100 parts by mass of the raw rice, 0.1 parts to 5 parts by mass of the oil and fat composition containing 0.1% to 3% by mass of lecithin and 0.002% to 1% by mass of ascorbic acid analog compound, when manufacturing boiled rice by boiling raw rice containing Japonica rice. In particular, undesirable odor caused after chilled storage of the boiled rice can be suppressed.

The raw rice contains preferably 50% to 100% by mass, more preferably 80% to 100% by mass, even more preferably 90% to 100% by mass, and most preferably 100% by mass of Japonica rice.

### Effects of Invention

By adding the oil and fat composition for rice cooking mixed with a predetermined amount of lecithin and ascorbic acid analog compound when cooking raw rice, hardening of the boiled rice during chilled storage can be suppressed, and boiled rice with reduced odor specific to rice species in Indica rice or the like can be cooked.

### DESCRIPTION OF EMBODIMENTS

The oils and fats used in the oil and fat composition for rice cooking of the present invention include, but are not particularly limited to, e.g. various vegetable oils and fats and animal oils and fats such as palm oil, palm kernel oil, coconut oil, corn oil, cottonseed oil, soybean oil, rapeseed oil, rice oil, sunflower oil, safflower oil, olive oil, peanut oil, kapok oil, sesame oil, evening primrose oil, cocoa butter, shea butter, sal butter, beef tallow, milk fat, lard, fish oil and whale oil, as well as processed oils and fats subjected to one or two or more treatments selected from hydrogenation, fractionation and transesterification. In the present invention, one or two or more oils and fats selected from them can be used. Preferably one or two or more oils selected from rapeseed oil, soybean oil, rice oil, corn oil, cottonseed oil, high-oleic sunflower oil and palm fractionated oil are used, more preferably one or two or more oils selected from rapeseed oil, soybean oil, rice oil, corn oil and palm fractionated oil are used, even more preferably, one or two or more oils selected from rice oil, rapeseed oil and soybean oil are contained. In addition, preferably the total amount of rice oil, rapeseed oil and soybean oil is not less than 80% by mass, and more preferably not less than 80% by mass of soybean oil is contained.

The content of the oils and fats contained in the oil and fat composition of the present invention is preferably not less than 80% by mass, more preferably not less than 90% by mass, and even more preferably not less than 94% by mass. Although there is no specific upper limit, the oils and fats are contained so that the contents of lecithin, the ascorbic acid analog compound and the oils and fats is not more than 100% by mass. The water content of the oil and fat composition of the present invention is 0% to 2% by mass, preferably 0% to 1% by mass, more preferably 0% to 0.5% by mass, even more preferably 0% to 0.2% by mass.

The lecithin used in the oil and fat composition for rice cooking of the present invention is a general term for lecithin idiomatically used in fields of foods or food additives. A lecithin composed of a mixture mainly comprising phospholipids, such as a pasty lecithin prepared from crude raw materials such as byproducts in purifying vegetable oils of soybean, rapeseed, corn, sunflower, palm, peanut and the like (e.g. hydrates generated in a degumming process) and egg yolk, a fractionation lecithin obtained by fractionating this crude raw material by a solvent, as well as an enzyme-degradable lecithin obtained by enzymatically treating this crude raw material, can be used. Although the lecithin is not particularly limited in the present invention, the pasty lecithin is preferable. Also, a lecithin derived from soybean or sunflower is preferable.

The content of the lecithin in the oil and fat composition for rice cooking is 0.1% to 3% by mass, preferably 0.1% to 2% by mass, and more preferably 0.3% to 2% by mass.

The content of acetone insoluble matters in the lecithin is preferably 50% to 100% by mass, more preferably 50% to 80% by mass, and even more preferably 55% to 70% by mass.

The content of the acetone insoluble matters in the lecithin can be measured according to the analytical test method in Japanese Standards of Food Additives. Specifically, it is a conversion value of the acetone insoluble matters obtained by the following measurement.

Mass (A) of about 2 g of lecithin is precisely weighed, put into a 50 mL graduated stoppered centrifuge tube, to which 3 mL of petroleum ether is added and dissolved, 15 mL of acetone is added and stirred thoroughly, and then left in ice water for 15 minutes. To this, acetone previously cooled to 0 to 5° C. is added so that the volume is 50 mL, stirred thoroughly, left in ice water for 15 minutes, then centrifuged at about 3000 rpm for 10 minutes, and the upper layer liquid is collected in a flask. Furthermore, acetone at 0 to 5° C. is added to the precipitate in the stoppered centrifuge tube so that the volume is 50 mL, stirred thoroughly while cooling in ice water, and then centrifuged in the same way. The upper layer liquid is combined with the preceding flask, distilled in a water bath, and the residue is dried at 105° C. for 1 hour, and its mass (B) is precisely weighed.

According to this measurement, the acetone insoluble matter content in lecithin is calculated by the following equation.

Acetone insoluble matter (mass %)=(1−B/A)×100

The ascorbic acid analog compound used in the present invention means an ascorbic acid, an ascorbate and an ascorbic acid ester. The ascorbic acid analogous compound is preferably an ascorbic acid and/or an ascorbic acid ester, more preferably an ascorbic acid ester, even more preferably an ascorbyl palmitate. The ascorbic acid ester has good solubility in oils and fats and is easy to handle.

The content of the ascorbic acid analog compound in the oil and fat composition for rice cooking of the present invention is 0.002% to 1% by mass, preferably 0.003% to 0.8% by mass, more preferably 0.005% to 0.5% by mass.

In addition, for the rice cooking method of the present invention, a conventional rice cooking method for raw rice can be used except that the oil and fat composition containing the lecithin and the ascorbic acid analog compound is added. The amount of the added oil and fat composition relative to 100 parts by mass of raw rice is 0.1 parts to 5 parts by mass, preferably 0.3 parts to 3 parts by mass.

The boiled rice according to the present invention means a matter obtained by cooking raw rice containing Japonica and/or Indica rice. Upon cooking raw rice, cereals such as barnyard millet, foxtail millet and wheat, and glucomannan as well as a rice analog which is formed into a shape of rice in such a way that nutrition functional components such as calcium and iron are kneaded thereinto may be contained. In that case, the masses of the cereals and the rice analog are included in the mass of the raw rice.

### Example

Hereinafter, the present invention will be described in more detail with reference to examples and comparative examples. However, the following examples do not limit the present invention.

The followings were used upon the implementation.

Rapeseed oil (manufactured by J-OIL MILLS, Inc.)
Soybean oil (manufactured by J-OIL MILLS, Inc.)
Rice oil (manufactured by J-OIL MILLS, Inc.)
Lecithin (lecithin AY; manufactured by J-OIL MILLS, Inc., acetone insoluble matter content: 60% by mass)
Ascorbyl palmitate (product name: Ascorbyl Palmitate, manufactured by Roche Vitamins Japan K.K.)

### (Dispersibility Test)

400 g of raw rice (Thai Indica rice; Kagura Ltd.) was washed, immersed in water at 25° C. for 90 minutes, transferred to a colander, and drained. Water was added to this rice so that the total amount was 1000 g. Furthermore, 1% of β-carotene formulation (manufactured by Mitsubishi-Kagaku Foods Corporation) was dissolved by heating in each oil and fat composition in Table 1 to prepare a red-colored oil and fat composition, and 2 g of the composition was added to rice, and the rice was cooked in a gas rice cooker (manufactured by Rinnai Corporation). The boiled rice was transferred to a tray and evaluated for the degree of coloring in a spread state. For the results of the evaluation, the uniformly dispersed oil (uniform red) was indicated by double circle, the partially unevenly distributed oil (partially deep red) was indicated by circle, the partially undistributed oil (partially white) was indicated by triangle, and the wholly unevenly distributed oil (many deep red parts and white parts) was indicated by cross.

### (Taste Evaluation of Boiled Rice 1)

400 g of raw rice (Thai Indica rice) was washed, immersed in water at 25° C. for 90 minutes, transferred to a colander, and drained. Water was added to this rice so that the total amount was 1000 g. Furthermore, 4 g of each oil and fat composition (each containing not more than 0.1% by mass of water) in Table 1 was added to the rice and mixed, and the rice was cooked in a gas rice cooker (manufactured by Rinnai Corporation) (rice without the oil and fat composition was also boiled). The boiled rice was transferred to a tray and cooled to room temperature by a decompression cooling device. After chilled storage (5° C.) for 3 days, the rice was heated to about 40° C. by a microwave oven, and the tastes were evaluated according to the following evaluation criteria.

### <Food Texture of Boiled Rice>

Circle: soft

Triangle: somewhat hard

Cross: hard

### <Odor>

Double circle: considerably low odor specific to Indica rice

Circle: low odor specific to Indica rice

Triangle: somewhat low odor specific to Indica rice

Cross: odor specific to Indica rice

TABLE 1

| | | Comparative | Comparative | | |
|---|---|---|---|---|---|
| | | Example | Example | Example | Example |
| | | 1-1 | 1-2 | 1-1 | 1-2 |
| oil | rapeseed oil | | 100 | 98.97 | |
| and | soybean oil | | | | 98.97 |
| fat | lecithin | | | 1.0 | 1.0 |
| comp- | ascorbyl | | | 0.03 | 0.03 |
| osition | palmitate | | | | |

| | | | | |
|---|---|---|---|---|
| dispersibility | — | Δ | ⊚ | ⊚ |
| food texture of | X | X | ◯ | ◯ |
| boiled rice | | | | |
| odor | X | X | ◯ | ⊚ |

*Unit in mixing the oil and fat composition is mass % in each case.

It turned out that the food texture of the boiled rice was good even after chilled storage and the odor specific to Indica rice could be reduced by adding the oil and fat compositions used in Examples 1-1 to 1-2 when cooking rice. On the other hand, when adding rapeseed oil when cooking rice in Comparative Example 1-2, the boiled rice had hard food texture due to chilled storage and the odor specific to Indica rice could not be reduced.

### (Taste Evaluation of Boiled Rice 2)

400 g of raw rice (Thai Japonica rice; Dia merchandise Co., Ltd.) was washed, immersed in water at 25° C. for 90 minutes, transferred to a colander, and drained. Water was added to this rice so that the total amount was 1000 g. Furthermore, 4 g of each oil and fat composition (each containing not more than 0.1% by mass of water) in Table 2 was added to the rice and mixed, and the rice was cooked in a gas rice cooker (manufactured by Rinnai Corporation). The boiled rice was transferred to a tray and cooled to room temperature by a decompression cooling device. After chilled storage (5° C.) for 3 days, the rice was heated to about 40° C. by a microwave oven, and the tastes were evaluated according to the following evaluation criteria.

### <Food Texture of Boiled Rice>

Circle: soft

Triangle: somewhat hard

Cross: hard

### <Odor>

Double circle: considerably low undesirable odor (rice bran odor)

Circle: low undesirable odor (rice bran odor)

Triangle: somewhat low undesirable odor (rice bran odor)

Cross: undesirable odor (rice bran odor)

TABLE 2

| | | Comparative | | |
|---|---|---|---|---|
| | | Example | Example | Example |
| | | 2-1 | 2-1 | 2-2 |
| oil and fat | rapeseed oil | 100 | 98.97 | |
| comp- | rice oil | | | 98.97 |
| osition | lecithin | | 1.0 | 1.0 |
| | ascorbyl palmitate | | 0.03 | 0.03 |

| | | | |
|---|---|---|---|
| food texture of boiled rice | x | ∘ | ∘ |
| odor | x | ∘ | ∘ |

* Unit in mixing the oil and fat composition is mass % in each case.

It turned out that the food texture of the boiled rice was good even after chilled storage and the undesirable odor (rice bran odor) could be reduced by adding the oil and fat compositions used in Examples 2-1 to 2-2 when cooking rice. On the other hand, when adding rapeseed oil when cooking rice in Comparative Example 2-1, the food texture of the boiled rice became hard due to chilled storage and the undesirable odor (rice bran odor) could not be reduced.

1. An oil and fat composition for rice cooking, containing oils and fats as well as 0.1% to 3% by mass of lecithin and 0.002% to 1% by mass of ascorbic acid analog compound.

2. The oil and fat composition for rice cooking according to claim 1, wherein the ascorbic acid analog compound is an ascorbic acid ester.

3. The oil and fat composition for rice cooking according to claim 1, wherein a content of acetone insoluble matters in the lecithin is 50% to 100% by mass.

4. The oil and fat composition for rice cooking according to claim 1, wherein the oils and fats contain one or two or more oils selected from rice oil, rapeseed oil and soybean oil.

5. The oil and fat composition for rice cooking according to claim 4, wherein the total amount of the rice oil, the rapeseed oil and the soybean oil is not less than 80% by mass.

6. A method for manufacturing boiled rice, comprising adding, relative to 100 parts by mass of raw rice, 0.1 parts to 5 parts by mass of the oil and fat composition containing 0.1% to 3% by mass of lecithin and 0.002% to 1% by mass of ascorbic acid analog compound, and cooking the raw rice with the oil and fat composition added.

7. A method for suppressing Indica rice-specific odor of boiled rice, comprising adding, relative to 100 parts by mass of the raw rice, 0.1 parts to 5 parts by mass of the oil and fat composition containing 0.1% to 3% by mass of lecithin and 0.002% to 1% by mass of the ascorbic acid analog compound, when manufacturing boiled rice by cooking raw rice containing Indica rice.

8. The method according to claim 7, wherein the raw rice contains 50% to 100% by mass of Indica rice.

9. A method for suppressing hardening of boiled rice during chilled storage, comprising comprises adding, relative to 100 parts by mass of the raw rice, 0.1 parts to 5 parts by mass of the oil and fat composition containing 0.1% to 3% by mass of lecithin and 0.002% to 1% by mass of ascorbic acid analog compound, when manufacturing boiled rice by cooking raw rice.

10. A method for suppressing undesirable odor of boiled rice, comprising adding, relative to 100 parts by mass of the raw rice, 0.1 parts to 5 parts by mass of the oil and fat composition containing 0.1% to 3% by mass of lecithin and 0.002% to 1% by mass of ascorbic acid analog compound, when manufacturing boiled rice by cooking raw rice containing Japonica rice.

11. The method according to claim 10, wherein the raw rice contains 50% to 100% by mass of Japonica rice.
